(19) United States
(12) Patent Application Publication
(10) Pub. No.: US 2023/0385023 A1
(43) Pub. Date: Nov. 30, 2023

(54) BIG DATA EVALUATION METHOD AND SYSTEM

(71) Applicant: XINJIANG INSTITUTE OF ECOLOGY AND GEOGRAPHY,CHINESE ACADEMY OF SCIENCES, WULUMUQI (CN)

(72) Inventors: ZENGYUN HU, WULUMUQI (CN); XI CHEN, WULUMUQI (CN); QIMING ZHOU, WULUMUQI (CN); DELIANG CHEN, WULUMUQI (CN); YUZHUO PENG, WULUMUQI (CN); JIAN ZHAO, WULUMUQI (CN); JING ZHANG, WULUMUQI (CN)

(21) Appl. No.: 17/828,546

(22) Filed: May 31, 2022

(51) Int. Cl. G06F 5/01; G06F 16/22; G06F 16/2458

(52) U.S. Cl. CPC G06F 5/01; G06F 16/2264; G06F 16/2462

(57) ABSTRACT

The present invention relates to a big data evaluation method and system. The method comprises steps of: determining evaluated data, reference data and different statistical indexes for data evaluation according to a preset experimental requirement; performing comparative calculation according to the evaluated data, the reference data and the statistical indexes to obtain corresponding numerical values of the statistical indexes; normalizing the numerical values of the statistical indexes to obtain normalized data; establishing a multi-dimensional spatial coordinate system according to the normalized data, and determining a distance value between the preset evaluation data and the reference data according to the multi-dimensional spatial coordinate system; and judging the comprehensive simulation capability of the evaluated data according to the distance value. The present invention can be applied to all natural sciences and social sciences involving data quality evaluation or object prioritization, and can quantify the comprehensive precision of multiple variables of different models.

### TECHNICAL FIELD

The present invention relates to the technical field of model performance, and in particular to a big data evaluation method and system.

### BACKGROUND

With the progress of science and technology and the development of social economy, big data explosion has become normal in different fields, such as industry, agriculture and transportation. Big data applications involve any subject in the natural sciences and social sciences, such as mathematics, biology and chemistry in the natural sciences, and philosophy, sociology and economics in the social sciences. In the face of vast big data, data quality is a precondition to ensure the wide application of big data. The quality evaluation of big data is challenging in the application of big data in various subjects.

Different statistical indexes are used to quantitatively evaluate the simulation capability of the model in different aspects. For example, the correlation coefficient (CC) is used to measure the degree and direction of linear correlation between the simulation time sequence and the observation time sequence; the absolute error (AE) is used to measure any persistent deviation (positive underestimation and negative overestimation) of the observed time sequence; and the root mean square error (RMSE) is used to quantify the average amplitude of the deviation. Some models may have a higher correlation coefficient (a higher CC value) during simulation, but have a larger deviation (a larger AE). The same is true for other models. Thus, it is impossible to accurately quantify the comprehensive simulation capability of the models. In addition, in the application process of the models, each model will have the output of multiple variables. For the comprehensive evaluation of the multi-variable simulation capability of the models, the existing evaluation systems cannot realize comprehensive quantitative evaluation.

### SUMMARY

To overcome the deficiencies in the existing technology, an objective of the present invention is to provide a big data evaluation method and system.

To achieve the above objective, the present invention provides the following schemes.

A big data evaluation method is provided, including steps of:
determining evaluated data, reference data and different statistical indexes for data evaluation according to a preset experimental requirement;
performing comparative calculation according to the evaluated data, the reference data and the statistical indexes to obtain corresponding numerical values of the statistical indexes;
normalizing the numerical values of the statistical indexes to obtain normalized data;
establishing a multi-dimensional spatial coordinate system according to the normalized data, and determining a distance value between the preset evaluation data and the reference data according to the multi-dimensional spatial coordinate system; and
judging the comprehensive simulation capability of the evaluated data according to the distance value.

Preferably, after the judging the comprehensive simulation capability of the evaluated data according to the Euclidean distance, the method further includes:
for a same piece of the evaluated data, calculating an absolute value of the difference between the normalized data corresponding to the evaluated data and the normalized data of the reference data;
weighting different statistical indexes according to the absolute value;
establishing a multi-dimensional spatial coordinate system according to the weighted statistical indexes, and determining an Euclidean distance between the preset evaluation data and the reference data according to the multi-dimensional spatial coordinate system; and
judging the comprehensive simulation capability of the evaluated data according to the Euclidean distance.

Preferably, each piece of the evaluated value corresponds to an experimental model.

Preferably, the performing comparative calculation according to the evaluated data, the reference data and the statistical indexes to obtain corresponding numerical values of the statistical indexes includes:
calculating the numerical values of the statistical indexes of each of the experimental models on the basis of the reference data, in which the expression of the numerical values of the statistical indexes is (sᵢ¹, sᵢ², . . . , sᵢⁿ), where i=0, 1, . . . , m, m is the difference between the number of the experimental models and 1, and (so, so, . . . , so) is the numerical value of the reference data relative to its own statistical index.

Preferably, the formula for normalizing the numerical values of the statistical indexes is:

$$( {nors}_{i}^{1} , {nors}_{i}^{2} , … , {nors}_{i}^{n} ) = ( \frac{{s}_{i}^{1}}{{p}^{1}} , \frac{{s}_{i}^{2}}{{p}^{2}} , … , \frac{{s}_{i}^{n}}{{p}^{n}} ) ;$$

where p^{j}=max(sᵢ^{j})−min(sᵢ^{j}), i=0, 1, . . . , m, j=1, 2, . . . n.

Preferably, the formula for determining the distance value between the preset evaluation data and the reference data according to the multi-dimensional spatial coordinate system is:

$$DISO = \sqrt{{( {nors}_{i}^{1} - {nors}_{0}^{1} )}^{2} + {( {nors}_{i}^{2} - {nors}_{0}^{2} )}^{2} + … + {( {nors}_{i}^{n} - {nors}_{0}^{n} )}^{2}} ;$$

where DISO is the distance value, and DISO₀ is the distance value between the reference data and the reference data itself when i=0.

Preferably, the formula for weighting different statistical indexes according to the absolute value is:

DISOᵢ=(wᵢ¹cᵢ¹)²+(wᵢ²cᵢ²)²+ . . . +(wᵢⁿcᵢⁿ)²;

where

$${w}_{i}^{j} = \frac{{c}_{i}^{j}}{{\sum }_{j = 1}^{n} {c}_{i}^{j}} ,$$

cᵢ^{j} is the absolute value, and cᵢ^{j}=|norsᵢ^{j}−nors₀^{j}|.

A big data evaluation system is provided, including:
a determination module configured to determine evaluated data, reference data and different statistical indexes for data evaluation according to a preset experimental requirement;
an index value calculation module configured to perform comparative calculation according to the evaluated data, the reference data and the statistical indexes to obtain corresponding numerical values of the statistical indexes;
a normalization module configured to normalize the numerical value of the statistical indexes to obtain normalized data;
a distance value calculation module configured to establish a multi-dimensional spatial coordinate system according to the normalized data and determine a distance value between the preset evaluation data and the reference data according to the multi-dimensional spatial coordinate system; and
a judgment module configured to judge the comprehensive simulation capability of the evaluated data according to the distance value.

In accordance with the specific embodiments provided by the present invention, the present invention discloses the following technical effects.

The present invention provides a big data evaluation method and system. The method includes steps of: determining evaluated data, reference data and different statistical indexes for data evaluation according to a preset experimental requirement; performing comparative calculation according to the evaluated data, the reference data and the statistical indexes to obtain corresponding numerical values of the statistical indexes; normalizing the numerical values of the statistical indexes to obtain normalized data; establishing a multi-dimensional spatial coordinate system according to the normalized data, and determining a distance value between the preset evaluation data and the reference data according to the multi-dimensional spatial coordinate system; and judging the comprehensive simulation capability of the evaluated data according to the distance value. The present invention can be applied to all natural sciences and social sciences involving data quality evaluation or object prioritization, and can quantify the comprehensive precision of multiple variables of different models.

### BRIEF DESCRIPTION OF DRAWINGS

To describe the technical schemes in the embodiments of the present invention or in the existing technology more clearly, the accompanying drawings to be used in the description of the embodiments will be briefly described hereinafter. Apparently, the accompanying drawings described hereinafter are only some of the embodiments of the present invention, and a person of ordinary skill in the art can obtain other accompanying drawings according to these accompanying drawings without paying any creative effort.

FIG. 1 is a flowchart of a method according to an embodiment of the present invention;

FIG. 2 is a diagram of a new one-dimensional big data quality evaluation system according to an embodiment of the present invention;

FIG. 3 is a diagram of a new two-dimensional big data quality evaluation system according to an embodiment of the present invention;

FIG. 4 is a diagram of a new three-dimensional big data quality evaluation system according to an embodiment of the present invention;

FIG. 5 is a schematic diagram of statistical measurement values according to an embodiment of the present invention; and

FIG. 6 is a connection diagram of system modules according to an embodiment of the present invention.

### DETAILED DESCRIPTION

The technical schemes in the embodiments of the present invention will be clearly and completely described below with reference to the accompanying drawings in the embodiments of the present invention. Obviously, the described embodiments are only some but not all of the embodiments of the present invention. All other embodiments obtained by a person of ordinary skill in the art on the basis of the embodiments of the present invention without paying any creative effort shall fall into the protection scope of the present invention.

An objective of the present invention is to provide a big data evaluation method and system, which can be applied to all natural sciences and social sciences involving data quality evaluation or object prioritization and can quantify the comprehensive precision of multiple variables of different models.

To make the objectives, features and advantages of the present invention more apparent and comprehensible, the present invention will be further described below in detail by specific implementations with reference to the accompanying drawings.

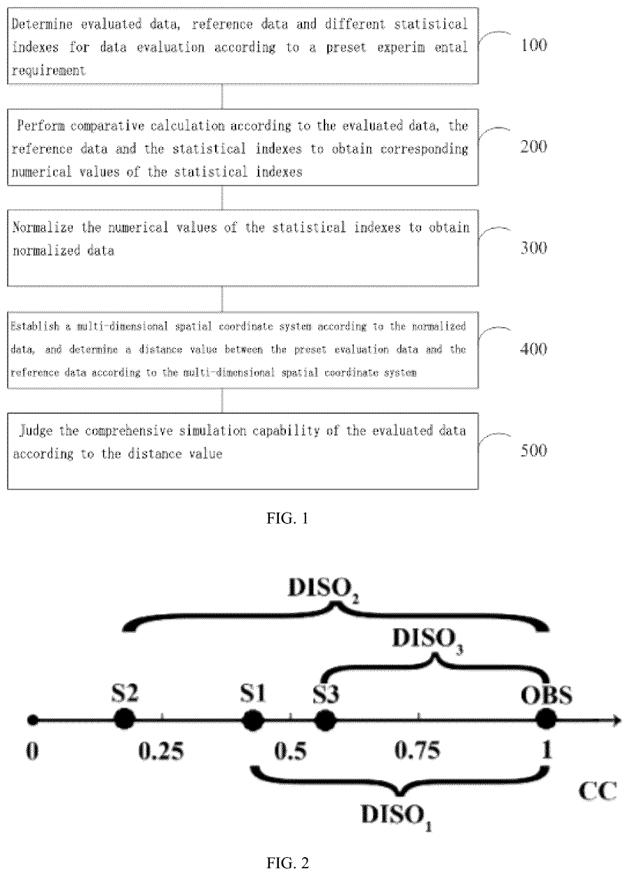

FIG. 1 is a flowchart of a method according to an embodiment of the present invention. As shown in FIG. 1, the present invention provides a big data evaluation method, including the following steps.

At step 100, evaluated data, reference data and different statistical indexes for data evaluation are determined according to a preset experimental requirement.

At step 200, comparative calculation is performed according to the evaluated data, the reference data and the statistical indexes to obtain corresponding numerical values of the statistical indexes.

At step 300, the numerical values of the statistical indexes are normalized to obtain normalized data.

At step 400, a multi-dimensional spatial coordinate system is established according to the normalized data, and a distance value between the preset evaluation data and the reference data is determined according to the multi-dimensional spatial coordinate system.

At step 500, the comprehensive simulation capability of the evaluated data is judged according to the distance value.

Preferably, after the step 500, the method further includes the following steps.

At step 600, for a same piece of the evaluated data, an absolute value of the difference between the normalized data corresponding to the evaluated data and the normalized data of the reference data is calculated.

At step 700, different statistical indexes are weighted according to the absolute value.

At step 800, a multi-dimensional spatial coordinate system is established according to the weighted statistical indexes, and an Euclidean distance between the preset evaluation data and the reference data is determined according to the multi-dimensional spatial coordinate system.

At step 900, the comprehensive simulation capability of the evaluated data is judged according to the Euclidean distance.

Preferably, each piece of the evaluated value corresponds to an experimental model.

Specifically, the flows in this embodiment are described below.

At flow 1, different statistical indexes for data evaluation are selected according to actual research requirements.

At flow 2, by comparing the evaluated data with the reference data and comparing the reference data with the reference data itself, the corresponding numerical values of the statistical indexes are calculated.

At flow 3, the dimensional statistical indexes are normalized by its range.

At flow 4, a multi-dimensional spatial coordinate system is established by utilizing the statistical indexes, the coordinate position of each piece of the evaluated data is determined, and the distance between the evaluated data and the reference data is calculated.

At step 5, the comprehensive simulation capability of the evaluated data is judged according to size of the distance value.

At flow 6, for a same piece of the evaluated data, different statistical indexes are weighted according to the absolute value of the difference between the normalized statistical indexes of the evaluated data and the normalized statistical indexes of the reference data, and the weighted distance can be obtained by repeating the flows 4 and 5. Similarly, the simulation capability of the model is judged according to the size of the distance.

Optionally, the selection of the statistical indexes at the flow 1 has very high flexibility. Different statistical indexes and the number of statistical indexes may be selected according to different research requirements. The statistical indexes are one-dimensional, two-dimensional, three-dimensional or infinite-dimensional, and the specific dimension is determined according to the number of selected statistical indexes.

Specifically, at the flow 2, during the calculation of the statistical indexes, in addition to the calculation of the statistical indexes of the evaluated data, the evaluation data and the statistical indexes of the evaluation data also need to be calculated. In this way, in the subsequent coordinate system, the evaluation data has a coordinate point.

Further, the flow 3 includes normalizing the statistical indexes. During the normalization process, only dimensional indexes are normalized. Each variable is divided by the range of the statistical indexes of the evaluated data.

In addition, the flow 4 includes forming a multi-dimensional spatial coordinate system by utilizing the normalized statistical indexes.

In this embodiment, the absolute value of the difference between the statistical indexes of the evaluated data and the statistical indexes of the reference data is calculated, the statistical indexes are weighted by utilizing the absolute value, and the distance is recalculated, so that the simulation performance of different evaluated data is judged. If the distance between the evaluated data and the reference data is smaller, the simulation performance of the model is better.

Preferably, the performing comparative calculation according to the evaluated data, the reference data and the statistical indexes to obtain corresponding numerical values of the statistical indexes includes:

calculating the numerical values of the statistical indexes of each of the experimental models on the basis of the reference data, in which the expression of the numerical values of the statistical indexes is (sᵢ¹, sᵢ², . . . , sᵢⁿ), where i=0, 1, . . . , m, m is the difference between the number of the experimental models and 1, and (so, so, . . . , so) is the numerical value of the reference data relative to its own statistical index.

In this embodiment, firstly, the detailed construction process in the evaluation method is given. Secondly, 1-dimensional, 2-dimensional and 3-dimensional evaluation systems are constructed by utilizing three pieces of model data and one piece of observed data, taking three common statistical variables CC, AE and RMSE as an example. Firstly, the detailed construction process in the evaluation method is given. Secondly, 1-dimensional, 2-dimensional and 3-dimensional evaluation systems are constructed by utilizing three pieces of model data and one piece of observed data, taking three common statistical variables CC, AE and RMSE as an example.

It is assumed that there are 1+m models (S₀, S₁, S₂, . . . , Sₘ), where S₀ is the reference data OBS and (S₁, S₂, . . . , Sₘ) is the evaluated data of m simulation models; and there are n statistical indexes, including (S₁, S², . . . , S^{m}). The construction process in the evaluation method includes the following steps.

At step 1, the statistical index values of each model in the form of (sᵢ¹, sᵢ², . . . , sᵢⁿ) are calculated through OBS, where i=0, 1, . . . , m, and (so, so, . . . , so) is the statistical index values of the OBS relative to the OBS itself.

Preferably, the formula for normalizing the numerical values of the statistical indexes is:

$$( {nors}_{i}^{1} , {nors}_{i}^{2} , … , {nors}_{i}^{n} ) = ( \frac{{s}_{i}^{1}}{{p}^{1}} , \frac{{s}_{i}^{2}}{{p}^{2}} , … , \frac{{s}_{i}^{n}}{{p}^{n}} ) ;$$

where p^{j}=max(sᵢ^{j})−min(sᵢ^{j}), i=0, 1, . . . , m, j=1, 2, . . . n.

Further, at the step 2 in this embodiment, all statistical indexes are normalized by dividing the statistical indexes by the range.

$$( {nors}_{i}^{1} , {nors}_{i}^{2} , … , {nors}_{i}^{n} ) = ( \frac{{s}_{i}^{1}}{{p}^{1}} , \frac{{s}_{i}^{2}}{{p}^{2}} , … , \frac{{s}_{i}^{n}}{{p}^{n}} ) ;$$

where p^{j}=max(sᵢ^{j})−min(sᵢ^{j}), i=0, 1, . . . , m, j=1, 2, . . . n. Since the CC has a value range of (−1, 1), it is unnecessary to normalize the CC.

Preferably, the formula for determining the distance value between the preset evaluation data and the reference data according to the multi-dimensional spatial coordinate system is:

$$DISO = \sqrt{{( {nors}_{i}^{1} - {nors}_{0}^{1} )}^{2} + {( {nors}_{i}^{2} - {nors}_{0}^{2} )}^{2} + … + {( {nors}_{i}^{n} - {nors}_{0}^{n} )}^{2}} ;$$

where DISO is the distance value, and DISO₀ is the distance value between the reference data and the reference data itself when i=0.

At the step 3 in this embodiment, the DISO is calculated by utilizing the Euclidean distance among (nor sᵢ¹, norsᵢ², . . . , nor sᵢⁿ):

$$DISO = \sqrt{{( {nors}_{i}^{1} - {nors}_{0}^{1} )}^{2} + {( {nors}_{i}^{2} - {nors}_{0}^{2} )}^{2} + … + {( {nors}_{i}^{n} - {nors}_{0}^{n} )}^{2}} , \qquad ( 1 )$$

where i=0, 1, . . . , m, and m is the number of the simulation models.

When i=0, DISO₀=0 indicates the distance between the OBS and the OBS itself. The DISO value of the simulation model is obtained by the formula (1). If the model has a smaller DISO value, the overall performance is better; and vice versa. By calculating the DISO values of different models, the comprehensive precision of different models can be obtained conveniently and quantitatively.

The models will output various different variables. For example, global climate models will simulate the atmospheric temperature and precipitation. If there are m global climate models (GCMs), in this embodiment, how to obtain the comprehensive simulation capability of the models for the two variables will be taken into consideration.

It can be known from the formula (1) that, for the atmospheric temperature and precipitation, the values of the GCMs are denoted by DISOᵢ^{te} and DISOᵢ^{pr}, respectively, where i=0, 1, . . . , m. Therefore, the overall performances of all models to simulate the two variables may be quantified as:

DISOᵢ=\sqrt{(DISOᵢ^{te}−DISO₀^{te})²+(DISOᵢ^{pr}−DISO₀^{pr})²,} (2)

where i=0, 1, . . . , m. Thus, the DISO value of each model is obtained, so that the comprehensive simulation capability of the models for the two variables is known. When the number of variables is greater than 1, the DISO values of the models may be calculated by the formula (2).

Preferably, the formula for weighting different statistical indexes according to the absolute value is:

DISOᵢ=\sqrt{(wᵢ¹cᵢ¹)²+(wᵢ²cᵢ²)²+ . . . +(wᵢⁿcᵢⁿ)²};

where

$${w}_{i}^{j} = \frac{{c}_{i}^{j}}{{\sum }_{j = 1}^{n} {c}_{i}^{j}} ,$$

cᵢ^{j} is the absolute value, and cᵢ^{j}=|norsᵢ^{j}−nors₀^{j}|.

In this embodiment, different evaluation indexes are weighted according to the research requirements, that is, weights are added in the formulae (1) and (2). Now, by taking the formula (1) as an example, if cᵢ^{j}=|norsᵢ^{j}−nors₀^{j}|, the equation (1) is expressed as follows:

DISOᵢ=\sqrt{(cᵢ¹)²+(cᵢ²)²+ . . . +(cᵢⁿ)²}, (3)

where i=0, 1, . . . , m, and m is the number of the models. For cᵢ^{j}, i=0, 1, . . . , m and j=1, 2, . . . n. The formula for calculating the weight wᵢ^{j} is

$${w}_{i}^{j} = \frac{c}{{\sum }_{j = 1}^{n} {c}_{i}} .$$

Thus, the weight of the formula (3) is:

DISOᵢ=\sqrt{(wᵢ¹cᵢ¹)²+(wᵢ²cᵢ²)²+ . . . +(wᵢⁿcᵢⁿ)²}, (4)

where Σⱼ₌₁ⁿwᵢ^{j}=1.

By repeating the above steps, the weights may also be added to multiple variables in the formula (2).

To better understand the evaluation method, the above equations are described by taking three statistical indexes (n=3) and three models (m=3) as an example in this embodiment. The three statistical indexes include CC, AE and RMSE. Three models (S1, S2, S3), the observed data OBS and the CC, AE and RMSE values among the OBS are defined.

For one dimension in the formula (1), only the CC is taken as an example in this embodiment. Thus, sᵢ¹=CCᵢ, where i=0, 1, 2, 3. The DISO form in the formula (1) is:

DISOᵢ=\sqrt{(CCᵢ−1)²}, (5)

where i=0, 1, 2, 3, and DISO₀=0.

For two dimensions in the formula (1), the CC and AE are taken as an example in this embodiment. Sᵢ=CCᵢ, and Sᵢ²=AEᵢ, where i=0, 1, 2, 3, . . . . Since AE₀=0, norAE₀=0, and the DISO form in the formula (1) is:

DISOᵢ=\sqrt{(CCᵢ−1)²+(norAEᵢ−0)²}, (6)

where i=0, 1, 2, 3, and DISO₀=0.

For three dimensions in the formula (1), the CC, AE and RMSE are taken as an example in this embodiment. Sᵢ¹=CCᵢ, Sᵢ²=AEᵢ, and Sᵢ³=RMSEᵢ, where i=0, 1, 2, 3.

Since RMSEᵢ≥0, RMSE₀=0 and norRMSE₀=0. The DISO in the formula (1) is:

DISOᵢ=\sqrt{(CCᵢ−1)²+(norAEᵢ−0)²+(norRMSEᵢ−0)²}, (7)

where i=0, 1, 2, 3 and DISO₀=0.

At step 4, the precision of the model is judged according to the size of the distance.

It can be seen from the above analysis that the statistical indexes and the DISO values calculated by the formula (1) are included in this embodiment and the comprehensive simulation performance of the model in different aspects can be described. When j>1 in the formula (1), the DISO value can quantify the “overall performance” of the model. The framework in this embodiment is the Euclidean distance, so it is easy to understand and accept. The statistical indexes and the number of statistical indexes (j=1, 2, . . . , n) may be flexibly selected by researchers according to the research requirements.

If a new statistical index is proposed in the future, this new statistical index may also be contained in the DISO formula (1). Generally, in this embodiment, it is suggested that three indexes, i.e., CC, AE and RMSE, are used to calculate the DISO value so as to construct the evaluation method and system. Each statistical index represents one aspect of the simulation performance of the model. The correlation coefficient, the normalized absolute error and the normalized root mean square error of the simulation model form a three-dimensional spatial coordinate system. In addition, the evaluation method and system can be applied to any subject in the natural sciences (e.g., mathematics, biology and chemistry) and social sciences (e.g., sociology, psychology and economics).

The application of the evaluation method in the meteorological field is described by an example. In this example, three statistical indexes (CC, AE and RMSE) and three simulation models are included, and the application of the method is explained one-dimensionally, two-dimensionally and three-dimensionally, respectively. Like the data used in Hu et al (2019), four sets of precipitation data are used in this embodiment, i.e., CN05.1 (observed data), the Medium-Range Weather Forecasts (ECMWF)s Atmospheric Reanalysis of the 20th Century (ERA-20C), the twentieth-century atmospheric model ensemble (ERA-20CM) and the ECMWFs Coupled Ocean Atmosphere Reanalysis of the 20th Century from ECMWF (CERA-20C). The reproducibility of three sets of reanalysis data to the mean annual precipitation in China from 1961 to 2012 under observation is researched; and the application of the system is explained one-dimensionally, two-dimensionally and three-dimensionally, respectively. (S₀, S₁, S₂, S₃)=(OBS, ERA-20C, ERRA-20CM, CERA-20C). In this experiment, the time sequence of the observed data is the mean annual precipitation in China from 1961 to 2012, and other three sets of reanalysis data including the ERA-20C, ERA-20CM and CERA-20C of the European Centre for Medium-Range Weather Forecasts (ECMWF) are calculated according to the CN05.1. The observation and reanalysis data are all monthly mean data and all interpolated to the spatial resolution of 0.5°×0.5°. Table 1 shows the values of CC, AE and RMSE among the three sets of reanalysis data and the observed data.

TABLE 1

| | CC | AE | RMSE |
|---|---|---|---|
| OBS | 1 | 0 | 0 |
| EAR-20C | 0.4307 | 74.05331 | 94.59994 |
| EAR-20CM | 0.178361 | 184.5961 | 191.7863 |
| CERA-20C | 0.573681 | 174.4418 | 179.1482 |

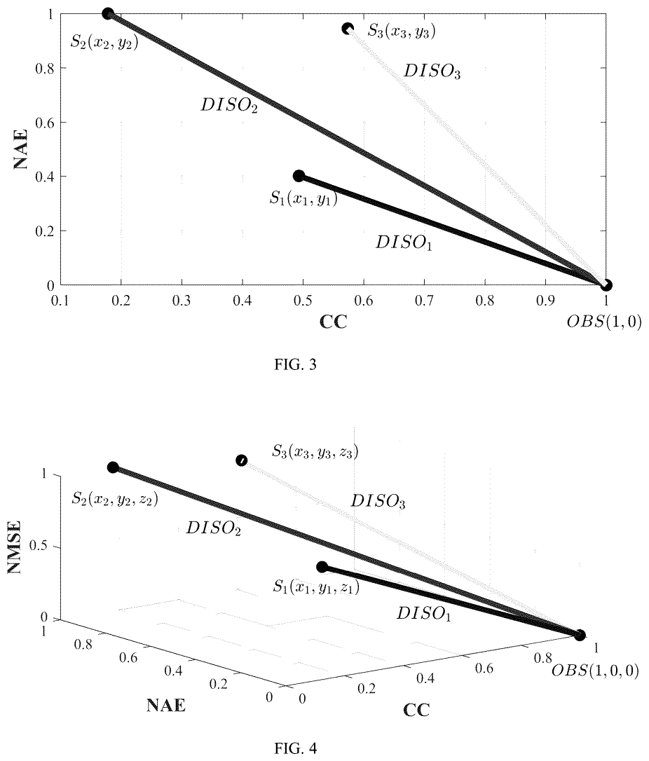

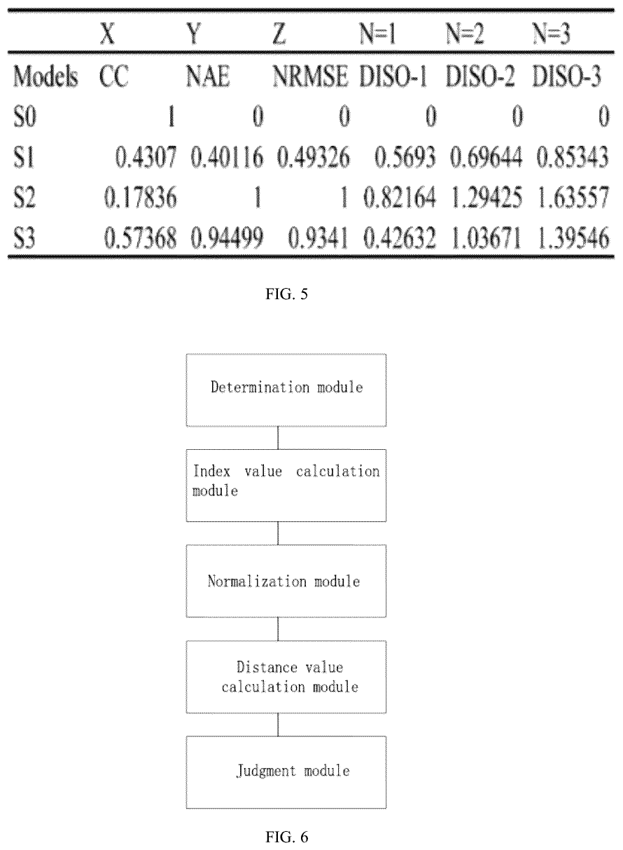

After calculation, FIGS. 2 to 5 show that the corresponding (CC₀, AE₀, RMSE₀)=(1, 0, 0) is the value of the OBS relative to the OBS itself. (CCᵢ, AEᵢ, RMSEᵢ) (where i=1, 2, 3) represent the statistical values of ERA-20C, ERA-20CM 1 and CERA-20C, respectively. FIGS. 2, 3 and 4 shows the 1-dimensional system, the 2-dimensional system and the 3-dimensional system, respectively. FIG. 5 provides all statistical measurement values. According to the DISO value, the overall simulation capability of the three sets of reanalysis data to the mean annual precipitation in China from 1961 to 2012 can be accurately obtained.

In the evaluation method provided in this embodiment, the distance between the statistical indexes of the simulated values and the observed values is utilized to quantitatively evaluate the overall simulation performance of different models for the reference model. This method can quantify the overall simulation performances of different models for the reference model, integrate multiple statistical indexes such as correlation coefficient, absolute error and root mean square error, and evaluate the simulation capability of the model for variables in various aspects. Therefore, the method can be applied to the comparison of different model data and the tracking of the change in model performance, and can identify high-precision models more accurately.

Corresponding to the above method, this embodiment further provides a big data evaluation system, including:
a determination module configured to determine evaluated data, reference data and different statistical indexes for data evaluation according to a preset experimental requirement;
an index value calculation module configured to perform comparative calculation according to the evaluated data, the reference data and the statistical indexes to obtain corresponding numerical values of the statistical indexes;
a normalization module configured to normalize the numerical value of the statistical indexes to obtain normalized data;
a distance value calculation module configured to establish a multi-dimensional spatial coordinate system according to the normalized data and determine a distance value between the preset evaluation data and the reference data according to the multi-dimensional spatial coordinate system; and
a judgment module configured to judge the comprehensive simulation capability of the evaluated data according to the distance value.

The present invention has the following beneficial effects.
(1) The theoretical background of the present invention is the Euclidean distance, and the DISO represents the distance. If the DISO has a smaller value, the comprehensive precision of the evaluated data is higher; otherwise, the comprehensive precision is lower. The present invention is simple, understandable and convenient to apply.
(2) The category selection and number determination of the statistical indexes in the present invention are flexible and targeted and totally depend on the specific research situation, and the corresponding dimension may be one dimension to n dimensions.
(3) In the present invention, during the calculation of the DISO numerical value, different statistical indexes can be weighted.
(4) In the present invention, the comprehensive precision of multiple variables of different models can be quantified.
(5) The present invention can be applied to any field and any subject.

The embodiments have been described progressively in this specification, each embodiment focuses on the differences from other embodiments, and the identical or similar portions of the embodiments can refer to each other.

Although the principle and implementations of the present invention have been described above by specific examples herein, the foregoing description of the embodiments is merely for facilitating the understanding of the method and core idea of the present invention. Meanwhile, various alterations to the specific implementations and applications may come to a person of ordinary skill in the art according to the concept of the present invention. In conclusion, the content of this specification shall not be regarded as limitations to the present invention.

1. A big data evaluation method, comprising steps of:
determining evaluated data, reference data and different statistical indexes for data evaluation according to a preset experimental requirement;
performing comparative calculation according to the evaluated data, the reference data and the statistical indexes to obtain corresponding numerical values of the statistical indexes;
normalizing the numerical values of the statistical indexes to obtain normalized data;
establishing a multi-dimensional spatial coordinate system according to the normalized data, and determining a distance value between the preset evaluation data and the reference data according to the multi-dimensional spatial coordinate system; and
judging the comprehensive simulation capability of the evaluated data according to the distance value.

2. The big data evaluation method according to claim 1, after the judging the comprehensive simulation capability of the evaluated data according to the Euclidean distance, further comprising:
for a same piece of the evaluated data, calculating an absolute value of the difference between the normalized data corresponding to the evaluated data and the normalized data of the reference data;
weighting different statistical indexes according to the absolute value;
establishing a multi-dimensional spatial coordinate system according to the weighted statistical indexes, and determining an Euclidean distance between the preset evaluation data and the reference data according to the multi-dimensional spatial coordinate system; and
judging the comprehensive simulation capability of the evaluated data according to the Euclidean distance.

3. The big data evaluation method according to claim 1, wherein each piece of the evaluated value corresponds to an experimental model.

4. The big data evaluation method according to claim 3, wherein the performing comparative calculation according to the evaluated data, the reference data and the statistical indexes to obtain corresponding numerical values of the statistical indexes comprises:
calculating the numerical values of the statistical indexes of each of the experimental models on the basis of the reference data, in which the expression of the numerical values of the statistical indexes is (sᵢ¹, sᵢ², . . . , sᵢⁿ), where i=0, 1, . . . , m, m is the difference between the number of the experimental models and 1, and (s₀¹, s₀², . . . , s₀ⁿ) is the numerical value of the reference data relative to its own statistical index.

5. The big data evaluation method according to claim 4, wherein the formula for normalizing the numerical values of the statistical indexes is:
$$( {nors}_{i}^{1} , {nors}_{i}^{2} , … , {nors}_{i}^{n} ) = ( \frac{{s}_{i}^{1}}{{p}^{1}} , \frac{{s}_{i}^{2}}{{p}^{2}} , … , \frac{{s}_{i}^{n}}{{p}^{n}} ) ;$$
where p^{j}=max(sᵢ^{j})−min(sᵢ^{j}), i=0, 1, . . . , m, j=1, 2, . . . n.

6. The big data evaluation method according to claim 4, wherein the formula for determining the distance value between the preset evaluation data and the reference data according to the multi-dimensional spatial coordinate system is:
$$DISO = \sqrt{{( {nors}_{i}^{1} - {nors}_{0}^{1} )}^{2} + {( {nors}_{i}^{2} - {nors}_{0}^{2} )}^{2} + … + {( {nors}_{i}^{n} - {nors}_{0}^{n} )}^{2}} ;$$
where DISO is the distance value, and DISO₀ is the distance value between the reference data and the reference data itself when i=0.

7. The big data evaluation method according to claim 4, wherein the formula for weighting different statistical indexes according to the absolute value is:
DISOᵢ=\sqrt{(wᵢ¹cᵢ¹)²+(wᵢ²cᵢ²)²+ . . . +(wᵢⁿcᵢⁿ)²};
where
$${w}_{i}^{j} = \frac{{c}_{i}^{j}}{{\sum }_{j = 1}^{n} {c}_{i}^{j}} ,$$
cᵢ^{j} is the absolute value, and cᵢ^{j}=|norsᵢ^{j}−nors₀^{j}|.

8. A big data evaluation system, comprising:
a determination module configured to determine evaluated data, reference data and different statistical indexes for data evaluation according to a preset experimental requirement;
an index value calculation module configured to perform comparative calculation according to the evaluated data, the reference data and the statistical indexes to obtain corresponding numerical values of the statistical indexes;
a normalization module configured to normalize the numerical value of the statistical indexes to obtain normalized data;
a distance value calculation module configured to establish a multi-dimensional spatial coordinate system according to the normalized data and determine a distance value between the preset evaluation data and the reference data according to the multi-dimensional spatial coordinate system; and
a judgment module configured to judge the comprehensive simulation capability of the evaluated data according to the distance value.
